(19) United States
(12) Patent Application Publication
(10) Pub. No.: US 2003/0076520 A1
(43) Pub. Date: Apr. 24, 2003

(54) Active packaging providing print media information

(76) Inventors: Robert E. Haines, St. Boise, ID (US); Judith A. Garzolini, Star, ID (US)

Correspondence Address: HEWLETT- PACKARD COMPANY, Intellectual Property Adminstration, P.O. Box 272400, Fort Collins, CO, 80527-2400, US

(21) Appl. No.: 09/981,466

(22) Filed: Oct. 17, 2001

(51) Int. Cl. G06F 3/12; H04N 1/23

(52) U.S. Cl. 358/1.12; 270/52.02; 399/45; 347/264; 347/101

(57) ABSTRACT

Arrangements and procedures are described to provide print media information to an imaging device independently of marking every sheet in a stack of print media and independently of repetitively marking portions on a roll of media after images have been formed on the roll. Specifically, an electronic tag is fixed to a medium. The electronic tag stores information that identifies a corresponding quantity and type of print media. After the medium has been loaded into an imaging device, the stored information is detected by the imaging device. The imaging device uses the detected information to automatically configure itself to print on each sheet or portion of a roll loaded print media.

### TECHNICAL FIELD

The described subject matter relates to optimizing imaging device operations based on print media information.

### BACKGROUND

Conventional imaging devices such as printers, plotters, copiers, facsimile machines and the like, typically utilize various types of print media to print images. Such print media types include paper based media (e.g., glossy paper, semi-glossy paper, matte paper, etc.) as well as non-paper based media (e.g., vellum, film, etc.).

To optimize print quality, an imaging device generally requires a number of parameters such as print modes, color maps, and so on, to be configured. This is because such parameters typically vary with the type of media being utilized. For example, an ink-based imaging device such as an ink jet printer that prints to an overhead transparency (OHT) designed for a laser printer may result in a print that not only may need to be re-imaged, but that also may result in gumming-up the internal assembly of the imaging device. This is because ink-based imaging devices use ink and laser-based OHTs do not generally have any ink retention coating. Accordingly, an ink-imaging device may adjust parameters such as printing speed, ink drying time, the amount of ink used, etc., to suit the particular print media being used.

In yet another example, a laser-based imaging device such as a laser printer that prints on an ink-based OHT may melt the ink-based OHT because ink-based OHTs are not manufactured to withstand the amount of heat typically generated by a laser printer's image fusing process. As a result, the imaging job may not only need to be re-imaged, but the job may also result in the need to replace printer parts if the incompatible print media melted onto internal parts of the laser printer. Accordingly, a laser-imaging device may adjust parameters such as the speed of printing, ink-fusing temperature, biasing voltage, and/or the like, to suit the particular print media being used.

Some imaging devices need to be manually configured to properly operate based on the print media type that is going to be used. Thus, print media type information and instructions are typically written on a media box. However, many users do not read the box or the instructions that accompany the media. If the user re-installs the print media on another printer, the user is often required to either remember or guess the media type. This is because once the user removes the media from the box for installation into the device, the box is generally thrown away, and the media data type and/or other instructions are often lost.

Accordingly, a number of conventional techniques have been developed for an imaging device to identify the particular type of print media that is loaded into an imaging device. For example, U.S. Pat. No. 7,148,162 to Huston et al., assigned to the assignee hereof, and incorporated herein by reference, describes marking each sheet of print media with eight separate indicia by imprinting the markings either on the face of each media sheet or on the side of each media sheet. E.g., two (2) barcodes are printed on each margin or edge of a sheet of media, which has four (4) margins/edges—top, right, bottom and left.

Such a conventional procedure to provide print media parameters to a printer has a number of disadvantages. One disadvantage, for example, is that print media marking costs can be substantially increased by the requirement to mark each sheet of print media with eight separate barcodes. An additional disadvantage is that up to eight separate sensors (e.g., optical sensors) are required to sense the sheet's eight markings—one dedicated sensor per marking. Requiring so many sensors generally increases printer fabrication costs. A further disadvantage is that such a procedure does not provide a way for the printing device to determine the quantity of print media that is loaded into the tray because each sheet is sensed individually. Thus, a user may not be able to easily determine if the printer has enough print media loaded into the tray to complete a print job.

Another conventional technique used by an imaging device to identify print media type is described in U.S. Pat. No. 7,047,110 to Smith, which is assigned to the assignee hereof and incorporated herein by reference. Smith describes marking a leading edge of a roll of print media with indicia such as a bar code to indicate media type and the remaining length of media left on the roll. An imaging device reads the marked indicia to obtain the information and then cuts the leading edge of the media off before printing to it. Once a print job is complete, the imaging device readies the media for a next print job by re-printing the information onto the leading edge of the roll.

Cutting off the leading edge of a roll of print media each time before processing a print job causes a substantial amount of wasted print media.

Accordingly, the following described arrangements and procedures address these and other problems of conventional techniques to provide printing parameters to imaging devices.

### SUMMARY

Arrangements and procedures are described to provide print media information to an imaging device independently of marking every sheet in a stack of print media and independently of repetitively marking portions on a roll of media after images have been formed on the roll. Specifically, an electronic tag is fixed to a medium. The electronic tag stores information that identifies a corresponding quantity and type of print media. After the medium has been loaded into an imaging device, the stored information is detected by the imaging device. The imaging device uses the detected information to automatically configure itself to print on each sheet or portion of a roll loaded print media.

### BRIEF DESCRIPTION OF THE DRAWINGS

FIG. 1 shows an exemplary image forming system that uses active media packaging to automatically provide print media information to an imaging device.

FIG. 2 shows an exemplary active media package that includes a stack, or “ream” of print media. Specifically, the active media package has an attached electronic tag for storing print media information that can be used by an imaging device to optimally configure itself to print to the media.

FIG. 3 shows an exemplary roll of print media that uses active packaging to automatically provide print media information to an imaging device. The active packaging is in the form of an electronic tag that is attached to the roll that contains the print media.

FIG. 4 shows an exemplary remaining portion of a package of print media.

FIG. 5 shows that when a radio frequency (RF) tag is incorporated into the actual packaging that contains or holds the print media, at least the electronic tag portion of the active packaging is loaded into an imaging device along with the print media.

FIG. 6 shows a stack of print media, wherein a last sheet in the stack is an information sheet that has an attached RF tag for storing information that can be used by an imaging device to optimally configure itself to print to the media.

FIG. 7 shows a stack of print media, wherein a first sheet in the stack is an information sheet that has an attached RF tag for storing information that can be used by an imaging device to optimally configure itself to print to the media.

FIG. 8 shows further details of an exemplary arrangement of an image forming device.

FIG. 9 shows exemplary electrical components to control operations of an image forming device.

FIG. 10 shows an exemplary procedure to generate an active package of print media.

FIG. 11 shows an exemplary procedure to provide information to an imaging device using an active package of print media.

### DETAILED DESCRIPTION

Overview

The described arrangements and procedures provide active packaging so that an imaging device can automatically obtain print media information as well as other information such as a remaining quantity of print media. An active package of print media (e.g., ream or a roll of print media) has an electronic tag operatively attached to the package. The electronic tag stores print media information and other information. The imaging device signals the electronic tag in a manner that allows the imaging device to acquire information stored on the tag.

In another aspect a single identification sheet (i.e., a top sheet or a bottom sheet) in a stack of print media has an electronic tag operatively attached to the sheet. The imaging device signals the electronic tag on the information sheet in a manner that allows the imaging device to acquire information stored on the tag.

An Exemplary Image Forming System

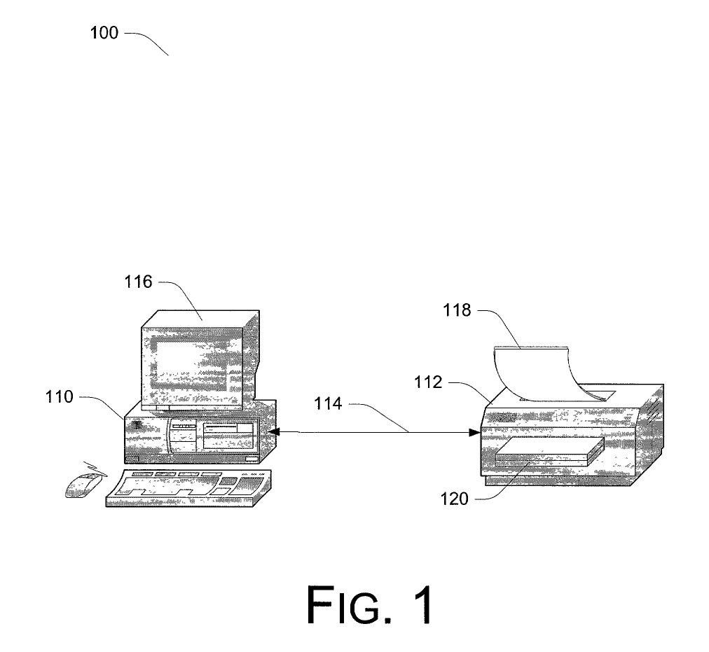

FIG. 1 shows an exemplary image forming system 100, which includes a host device 110, an image-forming device 112, and a communication medium 114 that operatively couples the host device to the imaging device. The host device is implemented as a personal computer (PC), server, Web Server, or other device configured to communicate with image forming devices. The host device includes a display 116 such as a CRT or flat-panel monitor to display information to a user.

An exemplary communication medium 114 includes a parallel connection, packet switched network, such as an intranet network (e.g., an Ethernet arrangement), the Internet, and/or other communication configurations operable to provide electronic exchange of information between the host device 110 and the image forming device 112 using an appropriate protocol. Other image forming system arrangements are possible including additional host devices, additional image forming devices, and so on, coupled with communication medium (e.g., a network arrangement).

The image forming device 112 is configured to form images upon print media 118. One exemplary image forming device is a printer, such as a laser printer, inkjet printer, a dot matrix printer, a dry medium printer, and a plotter. The described subject matter is embodied within other image forming device configurations such as multiple function peripheral devices, copiers, facsimile machines, plotters, and so on. The imaging device is arranged to form images upon the print media including, for example, paper, envelopes, transparencies, labels, etc. Print media may be in a number of different forms such as a stack, or ream of print media, folded print media, rolled print media, and the like. In this example, an active package of print media is loaded into the paper tray 120 allowing the imaging device to automatically obtain print media and other information.

An Exemplary Active Print Media Packaging

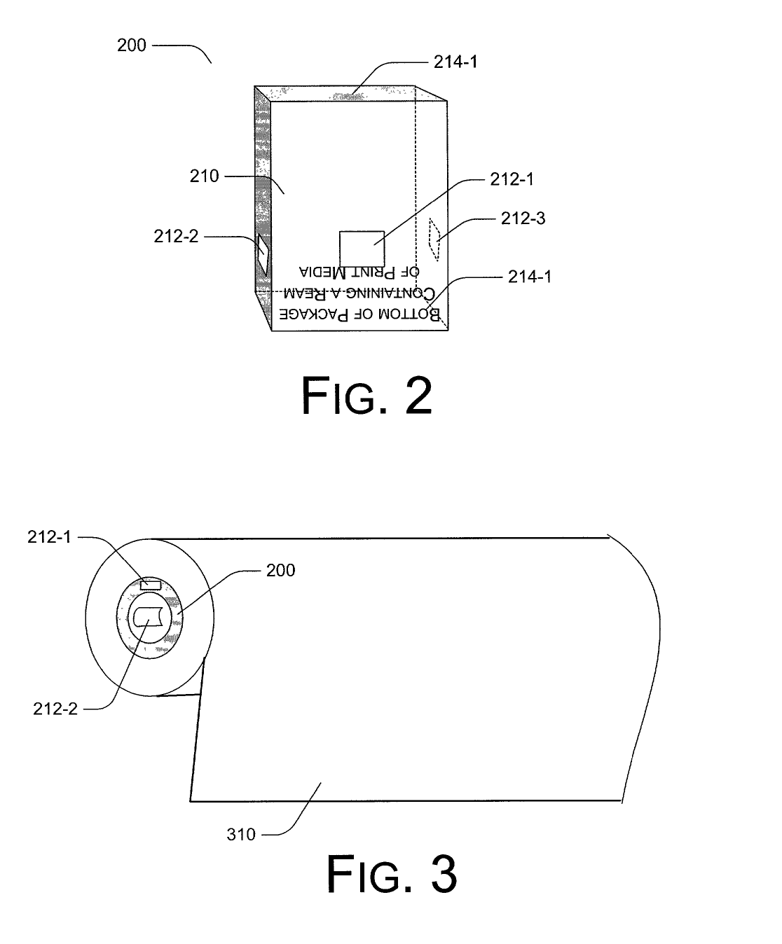

FIG. 2 shows an exemplary active media package 200 that includes a stack, or “ream” of print media 118 (see FIG. 1). The active media package is a container/holder of print media such as a box, an envelope, a roll, or the like. The package may be made out of any suitable material for the particular application such as paper, synthetic paper, reinforced paper, cardboard, plastic (including polyester, or the like).

An electronic tag 212 is attached to the active media package. The tag is pre-programmed, for example, as part of the paper packaging process, with information that is specific to the type of media in the package, quantity of media in the package, special operating parameters, and/or the like. For example, the electronic tag 212 can be a radio frequency RF(RF) tag that is coupled or attached to the packaging 200.

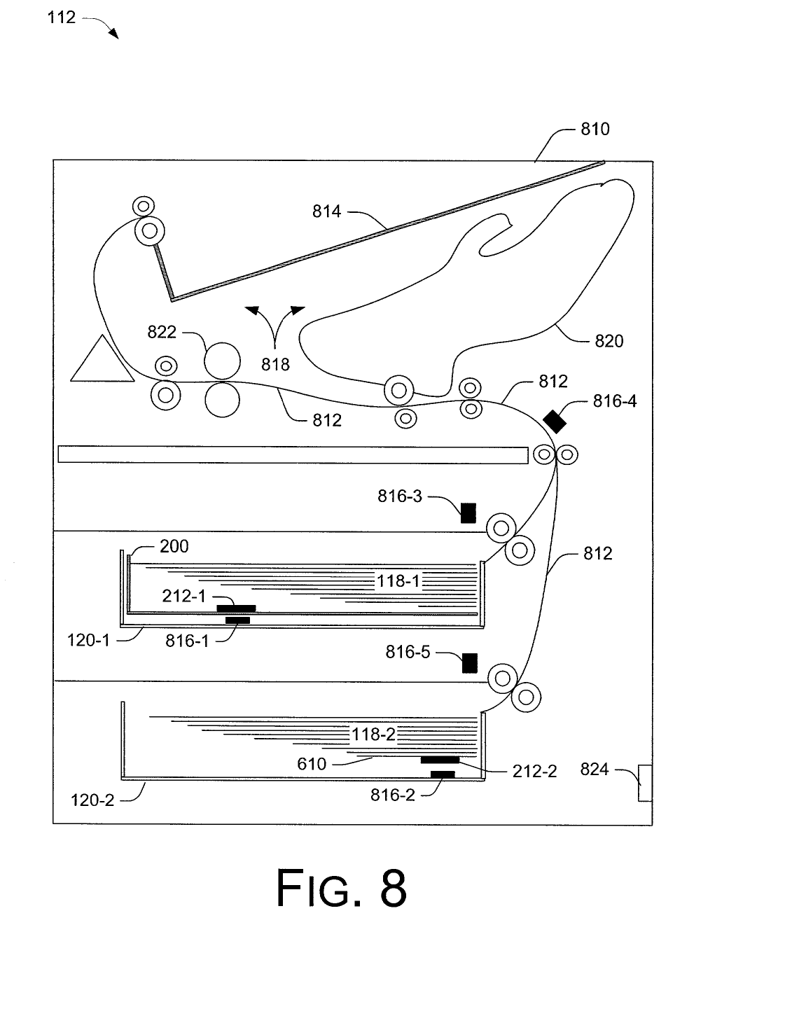

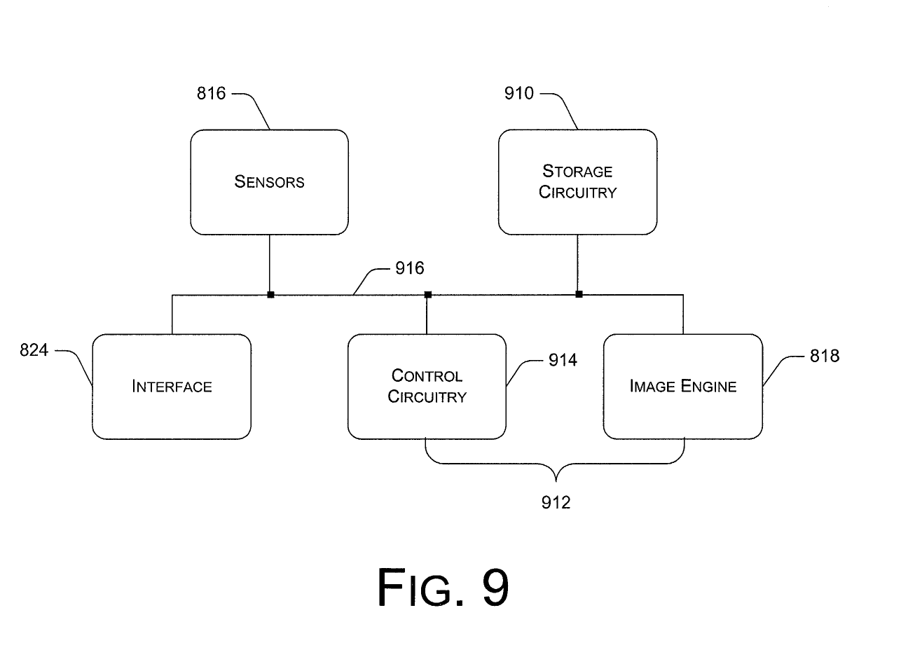

An RF tag 212 is optimally configured in proximity to an RF sensor that transmits an excitation signal to RF tag powering circuitry included in the RF tag. An RF sensor installed in an assembly of an imaging device is optimally positioned to read/write information to/from the RF tag 212. (An exemplary imaging device assembly and RF sensor position configuration is described below in reference to FIG. 8).

An RF tag 212 can be powered, written to, and read using inductive coupling or a combination of inductive power coupling and capacitive data coupling. Electrostatic coupling between the RF tag and the RF sensor can also be employed to power, encode with data, sense the data from the tag. Additionally, an RF tag can incorporate one or more antenna elements formed on an article such as print media packaging by printing a conductive pattern on the packaging using conductive ink.

An example of an RF tag/antenna configuration is described in U.S. Pat. No. 7,107,920 to Eberhardt et al., which is hereby incorporated by reference. (In each of these exemplary configurations, there is no requirement for a direct physical connection between the sensor and the tag).

Although this example shows that a number of electronic tags 212 are attached to the package 200, only one tag is necessarily coupled to the package. Multiple tags are shown attached to the package only to illustrate that a single tag 212 can be positioned in any one of a number of different optimal positions on the package 200. For example, the electronic tag may be placed on the top or the bottom of the packaging (e.g., electronic label 212-1), or on any other side of the packaging (e.g., electronic labels 212-2 and 212-3).

FIG. 3 shows an exemplary roll 300 of print media 310 that uses active packaging to provide at least print media type information to an imaging device. Specifically, the active packaging is the electronic tag 212 attached to the roll of print media. The roll may be made of any material such as cardboard, plastic, etc. Again, although this example shows a number of electronic tags, only one electronic tag needs to be attached to the roll. Multiple tags are shown attached to the package only to illustrate that a single tag 212 can be positioned in a number of different optimal positions on the package 300. For example, the electronic tag 212-1 is positioned on the end of the roll, whereas, electronic tag 212-2 is positioned on the inside of the roll.

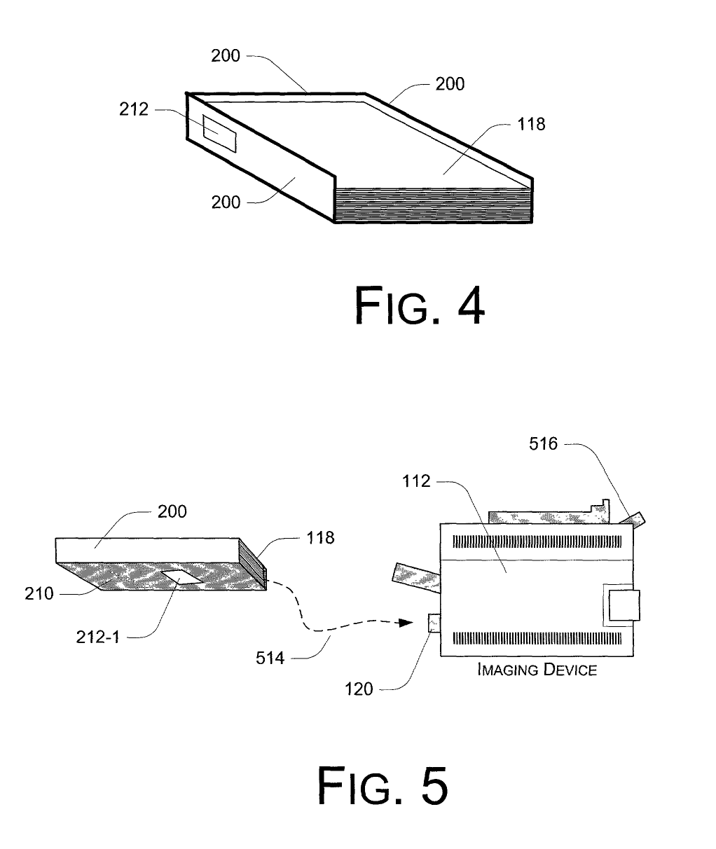

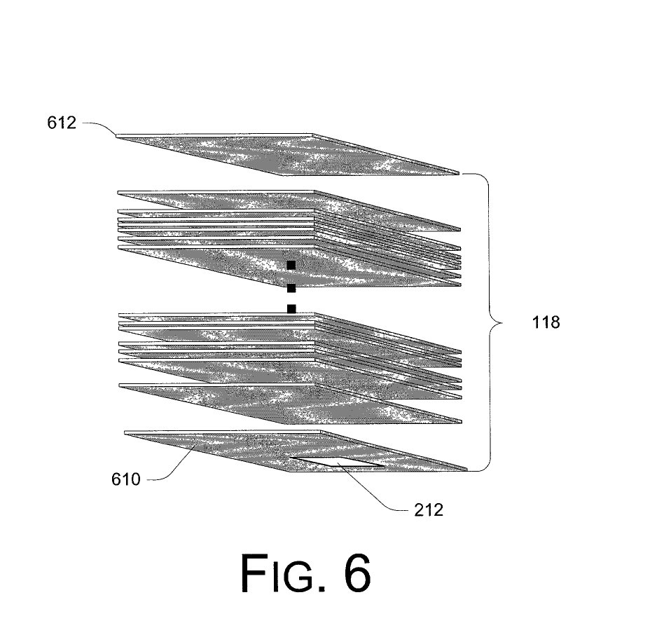

FIG. 4 shows an exemplary remaining portion of a package 200 and print media 118. The top and front portions of the package 200 have been removed so that the remaining portion of the package with the RF tag 212, and the print media 118 can be loaded into an imaging device 112 of FIG. 1 in a manner that allows the imaging device to access, or grab print media from the top of the stack (see, also FIG. 5).

The package 200 can be perforated to indicate portions of the packaging to be removed to allow an imaging device 112 to both access the print media in the package and to access to the RF tag 212 that is still attached to a remaining portion of package. For example, the electronic tag 212 is located on a side of the packaging 200. However, the electronic tag could also have been attached to any other portion of the packaging as long as the imaging device is able to access the print media 118 in the package and an RF sensor in the imaging device is able to access the electronic tag. Electronic tag sensors and sensor positioning are described in greater detail below in reference to an imaging device assembly of FIG. 8.

FIG. 5 shows that when a RF tag is incorporated into the actual packaging 200 that contains/holds the print media 118, the electronic tag portion of the active packaging is loaded into an imaging device along with the print media. The dotted line 514 shows that the print media 118 and a portion of the packaging 200 (the top and the front side of the packaging has been removed) are loaded into the media tray 120 (see tray 120 of FIG. 1). It can be appreciated that as long as the imaging device can detect the information stored on the tag (i.e., regardless of any particular configuration of print media packaging that includes the tag) that the imaging device can use the information to configure its operational parameters to form images on corresponding print media.

FIG. 6 shows a stack of print media 118. The last sheet in the stack of the print media 118 is an information sheet 610 that has an attached RF tag 212 for storing information that can be used by an imaging device to optimally configure itself for operation. When an imaging device removes print media 118 from the top of the stack, the information sheet is the last sheet in the stack, and an RF sensor/reader/writer can optimally be located at the bottom of a media tray 120 of FIG. 1. Thus, the imaging device is able not only to read a media type corresponding to the print media 118 from the tag 212, but the device is also able to write current information to the tag such as updating a number of pages remaining in the stack every time that a sheet is removed from the stack. (An exemplary RF tag sensor/reader/writer positioning is described in greater detail below in reference to FIG. 8).

Placing the information sheet 610 at the bottom of the stack has a number of additional advantages. For example, after a power cycle of an imaging device 112 or if the print media 118 is removed from the device before all of the sheets have been used, a device can resume an imaging operation using a partially used stack with accurate information at a later date.

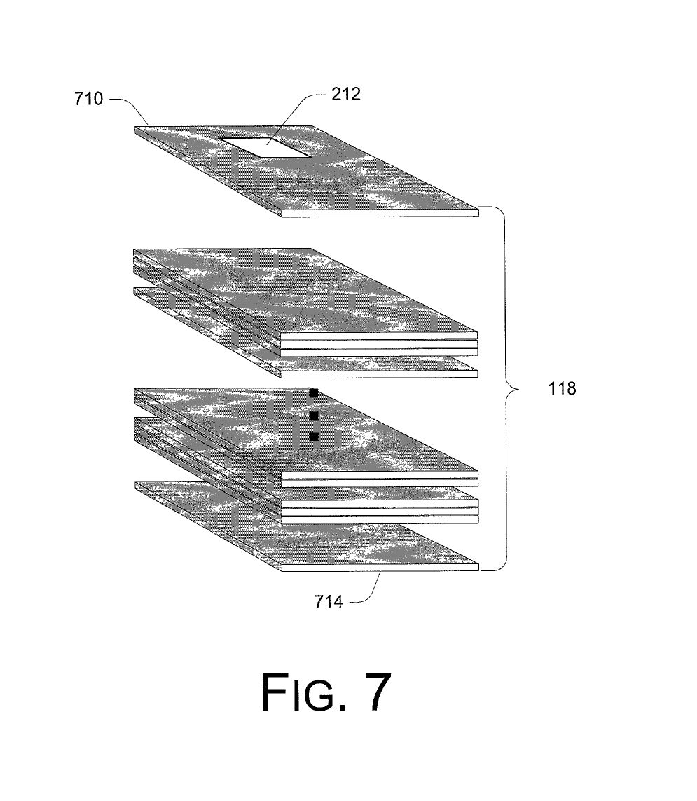

FIG. 7 shows a stack of print media 118. The first sheet 710 of print media in the stack is an information sheet that has an attached RF tag for storing information that can be used by an imaging device 112 to optimally configure itself. As an imaging device pulls the first sheet 710 from the top of the stack, the image device reads the tag 212 on the first sheet. The tag stores information that at least identifies the media type of print media 710 in the stack 712.

When the imaging device 112 removes print media from the top of the stack (rather than from the bottom of the stack), after the device obtains the information from the tag 212, the imaging device moves the information sheet 710 to an output bin such as the output bin 516 of FIG. 5 without printing on the information sheet. In this manner the imaging device is able to retrieve the information and provide optimized printing without requiring each sheet in the stack 710 to be imprinted with imaging device configuration parameters.

FIG. 8 shows further details of an exemplary arrangement of image forming device 112. The image forming device includes a housing 810 arranged to define a media path 812 to guide media within the housing. For example, a plurality of rollers is arranged within the housing to define the media path and to direct print media 118 from one or more media supplies 120 (e.g., media trays) to an output tray 814.

In the depicted arrangement, device 112 includes a plurality of media supplies 120. A first media supply 120-1 includes a package 100 of print media 118. The package has data thereon as RF tag 212-1. A second media supply 120-2 does not include packaging 100. Instead, supply 120-2 includes an information sheet 610 (see, FIG. 6) as the last sheet in the stack of print media. The information sheet has data thereon as RF tag 212-2. The data is used by device 112 to configure itself and to form images upon the print media. The data stored on an RF tag 212 is read from media supplies 120 by a sensor 816 that is described in further detail below.

The exemplary image forming device 112 further includes an image engine 818 adjacent media path 812 and arranged to print or otherwise form images upon media 118. An exemplary image engine includes a print engine including a developing assembly 820 and a fusing assembly 822 in the depicted configuration. Control circuitry (not shown in FIG. 8) discussed below is configured to control operations of device 112 including controlling operations of developing and fusing assemblies 820 and 822 as described in further detail below.

The image forming device 112 includes a sensor 816 configured to obtain/write data from an RF tag 212 that is located either on the packaging material that contains print media or on a separate sheet of print media. As discussed above, an RF tag 212 may be powered and read/written to/from using inductive coupling or a combination of inductive power coupling and capacitive data coupling. Or, electrostatic coupling between the RF tag and the RF sensor can be employed. In yet another configuration, the RF tag may employ at least one or more antenna elements that are formed on the article by printing a conductive pattern on the packaging using conductive ink.

Thus, plural configurations of sensor 816 are possible depending upon the type of media 118 being utilized (e.g., a stack of print media as compared to a roll of print media (see, roll 300 of FIG. 3)) and depending on the technology used to implement the RF tag/RF sensor coupling. In one configuration, an RF sensor is positioned to monitor respective media supplies 120 adjacent to a respective print media supply 120 (e.g., a sensor 816-1 and 816-2 is positioned underneath a print media tray 120). In yet another configuration, a sensor 816 is provided at one or more locations along media path 812 (e.g., sensors 816-3 and 816-4 are located along the media path).

Image forming device 112 includes an interface 824 configured to couple with communications medium 114 of FIG. 1 for implementing communications externally of device 112 with host device 110 or other external devices. Interface 824 receives image data from the communication medium and the imaging device subsequently forms images upon media 118 using image data received via interface 824. In one configuration, interface 824 is implemented as a JetDirect® card that is available from Hewlett-Packard Company.

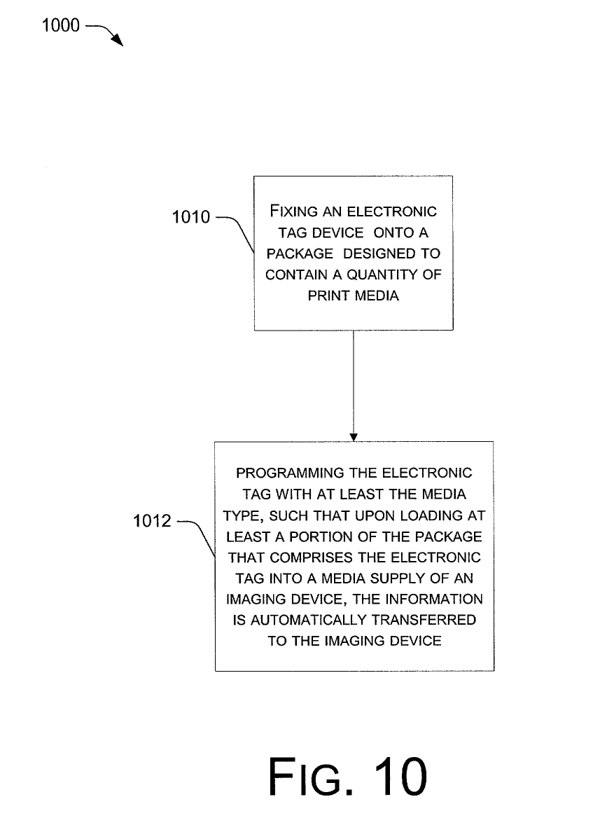

FIG. 9 shows exemplary electrical components to control operations of image forming device 112. The depicted electrical circuitry includes sensors 816, interface 824, storage circuitry 910 and imaging circuitry 912 (imaging circuitry 912 includes control circuitry 914 and image engine 818 comprising assembly's 820 and 822 of FIG. 8). Further a communication medium 916 configured to implement appropriate communications is provided intermediate internal components of image forming device 112. In one arrangement, communication medium 916 is implemented as a bidirectional bus.

Storage circuitry 910 is configured to store electrical information such as image data for using and formulating hard images and instructions usable by control circuitry 914 for implementing image forming operations within device 112. Exemplary storage circuitry 910 includes nonvolatile memory (e.g., flash memory, EEPROM, and/or read-only memory (ROM)), random access memory (RAM), and hard disk and associated drive circuitry.

Control circuitry 914 can be implemented as a processor such as a dedicated microprocessor configured to execute software and/or firm or executable instructions. Control circuitry 914 implement processing of image data (e.g., rasterization) received via interface 824. Further, control circuitry 914 of imaging circuitry 912 performs functions with respect to the formation of images including controlling operations of image engine 818 including developing assembly 820 and fusing assembly 822 in the described configuration. For example, control circuitry 914 obtains data via appropriate signals from one or more of sensors 816 and adjusts imaging parameters of image engine 818 during formation of images.

Image forming device 112 is configured according to the type of print media being image upon. Different types of media 118 have various weights, surface finishes, roughness, wicking properties, etc. which impact equality of images formed thereupon. The imaging parameters of device 112 including image engine 818 are adjusted by control circuitry 914 to optimize the formation of quality images upon media 118 responsive to the types of media utilized as indicated by the data stored on an RF tag 212.

Storage circuitry 910 can be configured to store a plurality of settings for one or more imaging parameters corresponding to a plurality of respective media types. Such can be implemented, for example, in a lookup table within storage circuitry 910. Upon identification of an RF tag 212 detected by a sensor 816, the appropriate imaging parameters settings are obtained by control circuitry 914 for configuring device 112. The parameters settings may be used directly to configure device 112 or for providing initial settings which may be subsequently modified based on other information to optimize imaging.

Using an Active Package of Print Media

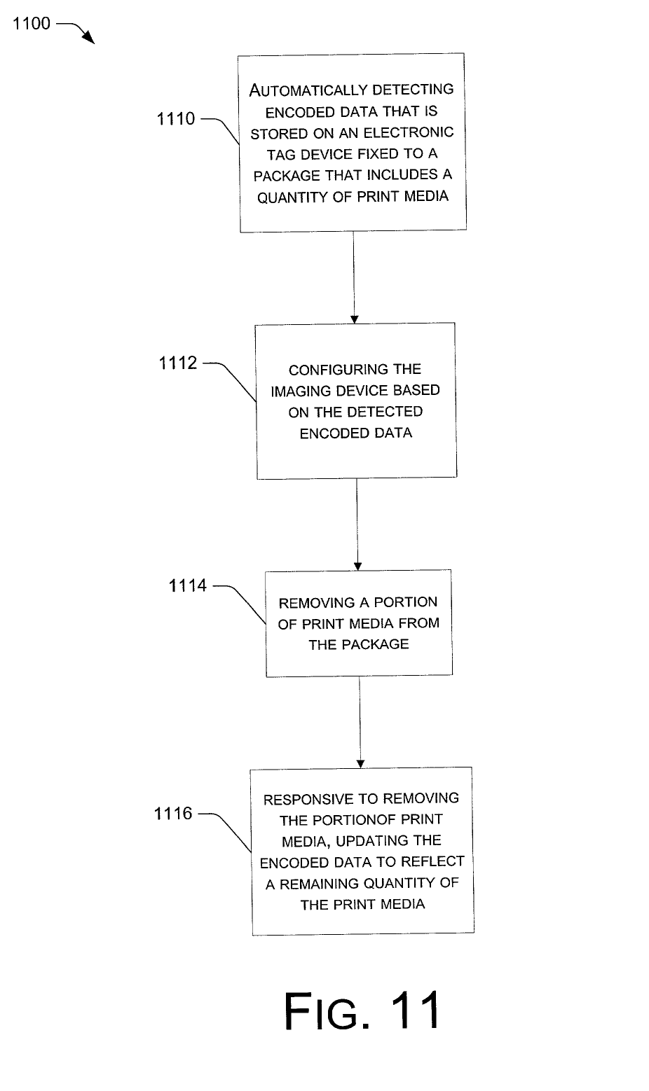

FIG. 10 shows an exemplary procedure 1000 to generate an active package of print media. At block 1010, the procedure fixes an electronic tag onto a package that is designed to contain a particular quantity of print media or a particular print media type. At block 1012, the procedure stores information on the electronic tag. The information includes at least the print media type. The electronic tag is positioned on the package such that upon loading at least a portion of the package that comprises the electronic tag into a media supply of an imaging device the information can be automatically transferred to the imaging device. This transferred information can be used by the imaging device for configuration and other purposes such as display to a user.

FIG. 11 shows an exemplary procedure 1100 to provide information to an imaging device using an active package of print media. The electronic tag is an RF tag that is attached to a portion of the print media package. At block 1110, the imaging device detects data stored on an electronic tag that is fixed to a package. The data includes at least an indication of the media type of the print media. The package includes a quantity of print media of a particular media type that is loaded in a media supply of an imaging device. The print media, for example, can be packaged in a ream, a roll, and so on.

Accordingly, the data can be detected by an imaging device independent of any indicia that may or may not be imprinted (e.g., a barcode) on any particular portion of the print media. This is because the data is stored on an electronic tag that is fixed to the packaging that contains print media or is designed to contain/hold print media.

At block 1112, the imaging device configures itself based on the detected data (block 1110). The data stored on the electronic tag may include an indication of the amount of print media that is contained or attached to the package. In block 1114, the procedure 1100 removes a portion such as a sheet or a length of print media from the package.

At block 1116, responsive to the removal of a portion of the print media, the imaging device updates the data to indicate the amount of print media remaining. This information can also be displayed on a display device, and/or presented to a computer program application to determine if there is enough print media to complete a print job. Additionally, as the imaging device processes a print job, the electronic device can be automatically updated to indicate the current amount of print media left in the stack or on the roll.

Conclusion

Through the use of active packaging of print media, an imaging device is able to obtain print media and other information: (a) without requiring each sheet of print media in a stack to be separately marked; (b) without impacting print quality; (c) being able to sense media types before they are loaded into the imaging device (e.g., while print media is in a tray); and (d) in a substantially less manufacturing intensive manner than conventional print media detection techniques.

Although the subject matter has been described in language specific to structural features and/or methodological operations, it is to be understood that the subject matter defined in the appended claims is not necessarily limited to the specific features or operations described. Rather, the specific features and operations are disclosed as preferred forms of implementing the claimed invention. For example, even though the various embodiments of the subject matter are described generally in the context of an imaging device that utilizes a stack of print media. It is, however, understood that the subject matter is equally applicable to other types of imaging devices that either employ other types of media such as roll media.

1. A medium comprising an electronic tag fixed to the medium, the electronic tag storing information that identifies a corresponding quantity and type of print media.

2. A medium as recited in claim 1, wherein the electronic tag is a radio frequency tag.

3. A medium as recited in claim 1, wherein the medium is a sheet in a stack.

4. A medium as recited in claim 1, wherein the medium is a sheet in a roll.

5. A medium as recited in claim 1, wherein the medium is a package designed to contain print media.

6. A medium as recited in claim 1, wherein the information further comprises a number of sheets of print media contained in a package of print media or a length of print media in a roll of print media.

7. A method for packaging print media, the method comprising:
fixing an electronic tag onto a package designed to contain a quantity of print media of a media type; and
storing information on the electronic tag, the information comprising at least the media type, such that upon loading at least a portion of the package that comprises the electronic tag into a media supply of an imaging device, the information is automatically transferred to the imaging device.

8. A method as recited in claim 7, wherein the quantity of print media is a stack of print media.

9. A method as recited in claim 7, wherein the quantity of print media is a roll of print media.

10. A method as recited in claim 7, wherein the electronic tag is a radio frequency tag.

11. A method as recited in claim 7, wherein the information further comprises a number of sheets of print media contained in the package or a length of print media that is contained on the package.

12. A method to automatically provide print media information to an imaging device, the method comprising:
detecting, by an imaging device, data stored on an electronic tag; and
automatically configuring the imaging device based on the data.

13. A method as recited in claim 12, wherein the electronic tag is fixed to a portion of a package that comprises a quantity of print media, the portion being loaded in a media supply of an imaging device.

14. A method as recited in claim 12, wherein detecting the data is independent of any indicia imprinted on any particular one of the quantity of print media.

15. A method as recited in claim 12, wherein the data comprises at least a media type that corresponds to the quantity of print media.

16. A method as recited in claim 12, wherein the quantity of print media is a stack of print media.

17. A method as recited in claim 12, wherein the quantity of print media is a roll of print media.

18. A method as recited in claim 12, wherein the electronic tag is a radio frequency tag that is attached to the package.

19. A method as recited in claim 12, wherein the data further comprises a value that indicates a number of sheets of print media contained in the package or a length of print media that is contained on the package.

20. A method as recited in claim 12, wherein the data further comprises a value to indicate a remaining quantity of print media; and,
wherein the method further comprises:
removing at least one portion of the quantity of print media from the package; and
responsive to removing the at least one portion, updating the value to reflect a number of sheets remaining of the quantity of print media or an available length remaining of the quantity of print media.

21. A method as recited in claim 12, wherein the data further comprises a value that indicates an amount remaining of the quantity of print media; and,
wherein the method further comprises:
responsive to detecting the data, presenting the amount remaining on a display device for viewing, and/or presenting the value to a computer program application to determine if there is enough print media to complete a print job.

22. A computer-readable medium comprising computer-executable instructions to automatically provide print media information to an imaging device, the computer-executable instructions comprising instructions for:
detecting data stored on an electronic tag; and
configuring the imaging device based on the data.

23. A computer-readable medium as recited in claim 22, wherein the electronic tag is fixed to a package, the package comprising a quantity of print media, the package being loaded in a media supply of an imaging device.

24. A computer-readable medium as recited in claim 22, wherein detecting the data is independent of any indicia imprinted on any particular one of the quantity of print media.

25. A computer-readable medium as recited in claim 22, wherein the data comprises at least a media type that corresponds to the quantity of print media.

26. A computer-readable medium as recited in claim 22, wherein the tag is a radio frequency tag that is attached to the package.

27. A computer-readable medium as recited in claim 22, wherein the data further comprises a value that indicates a number of sheets of print media contained in a package or a length of print media that is contained on the package.

28. A computer-readable medium as recited in claim 22, wherein the data further comprises a value to indicate a remaining quantity of print media; and,
wherein the computer-executable instructions further comprise instructions for:
removing at least one portion of the quantity of print media from a package; and
responsive to removing the at least one portion, updating the value to reflect a number of sheets remaining of the quantity of print media or an available length remaining of the quantity of print media.

29. A computer-readable medium as recited in claim 22, wherein the data further comprises a value that indicates an amount remaining of the quantity of print media, and wherein the computer-executable instructions further comprise instructions for:
responsive to detecting the data, presenting the amount remaining on a display device for viewing, and/or presenting the value to a computer program application to determine if there is enough print media to complete a print job.

30. A method to automatically provide print media information to an imaging device, the method comprising:
loading a plurality of sheets of print media into a feed path of an imaging device, at least one subset of the print media having a particular print media type, the sheets comprising a particular one sheet that comprises an electronic tag, the electronic tag being configured to identify information corresponding to each of the other sheets of print media, the information comprising at least the particular print media type;
generating a signal that results in a transfer of the information to the imaging device;
receiving the information; and
responsive to receiving the information, automatically configuring the imaging device based on the particular media type.

31. A method as recited in claim 30, wherein the particular one sheet is a media type that is different than the particular media type of the sheets.

32. A method as recited in claim 30, wherein the electronic tag is a radio frequency tag.

33. A method as recited in claim 30, wherein the sheets include a top sheet and a bottom sheet, wherein the particular one sheet is a first sheet that is the top sheet, and wherein the method further comprises:
removing the top sheet from the sheets; and
wherein generating the signal is performed responsive to removing the top sheet.

34. A method as recited in claim 30, wherein the sheets include a top sheet and a bottom sheet, wherein the particular one sheet is a last sheet that is the bottom sheet, wherein the information further comprises a value that indicates a number of sheets remaining of the sheets, and wherein the method further comprises:
removing a sheet from the sheets; and
wherein generating the signal is performed responsive to removing the sheet.

35. A method as recited in claim 30, wherein the information further comprises a value that indicates a number of sheets remaining of the sheets; and,
wherein the method further comprises:
responsive to receiving the information, presenting the value on a display device for viewing or presenting the value to a computer program application such that the value is available to determine if there is enough print media to complete a printing job.
